(19) United States
(12) Patent Application Publication
(10) Pub. No.: US 2003/0068154 A1
(43) Pub. Date: Apr. 10, 2003

(54) Gateway content storage system having database indexing, and method thereof

(76) Inventor: Edward Zylka, Lake Forest, IL (US)

Correspondence Address: RADER FISHMAN & GRAUER PLLC, LION BUILDING, 1233 20TH STREET N.W., SUITE 501, WASHINGTON, DC, 20036, US

(21) Appl. No.: 10/286,844

(22) Filed: Nov. 4, 2002

Related U.S. Application Data
(63) Continuation-in-part of application No. 09/931,465, filed on Aug. 17, 2001.
Application No. 09/931,465 is a continuation-in-part of application No. 09/810,667, filed on Mar. 19, 2001.
Application No. 09/810,667 is a continuation-in-part of application No. 09/520,968, filed on Mar. 8, 2000.

(51) Int. Cl. H04N 5/781

(52) U.S. Cl. 386/46; 386/125

(57) ABSTRACT

The present invention includes a gateway, a content storage medium, and a database. The gateway receives multimedia content from a content provider or from at least one media device. The media device may be co-located with the gateway or remotely-located from the gateway. The gateway annotates the received multimedia content, using alphanumeric annotation or voice annotation, to create metadata. This metadata are information that describes the received multimedia content. The content storage medium stores the annotated multimedia content, and the database stores the metadata. The gateway is linked through a wired network or a wireless network to the media device, a television, the content storage medium, and/or the multimedia content provider.

### RELATED APPLICATIONS

This application is a Continuation-in-Part of U.S. patent application Ser. No. 09/931,465 entitled “Personal Versatile Recorder: Enhanced Features, And Methods For Its Use,” filed on Aug. 17, 2001, which is a Continuation-in-Part of U.S. patent application Ser. No. 09/810,667 entitled “Personal Versatile Recorder: Enhanced Features, And Methods For Its Use,” filed on Mar. 19, 2001, which is a Continuation-in-Part of U.S. patent application Ser. No. 09/520,968 entitled, “Personal Versatile Recorder And Method Of Implementing And Using Same,” filed on Mar. 8, 2000.

### FIELD OF THE INVENTION

The present invention relates to the field of multimedia recording and playback. More specifically, the present invention relates to the ability of indexing multimedia content for storage and retrieval.

### BACKGROUND OF THE INVENTION

Presently available electronic devices, such as video players, video recorders and cameras, permit the capture of multimedia content. This multimedia content includes movie files and data images. Nevertheless, there are still shortcomings in the electronic devices presently available.

Specifically, some presently available electronic devices do not offer the advantage of permitting collection of movie files and data images along with the annotation of this collected content. In these devices, using an annotation to index the captured multimedia content is not readily available. Typically, even when annotation is included as a feature, either the presently available electronic devices lack the flexibility in customizing the annotation, or the amount of information provided as an annotation can be insufficient due to the storage limitations contained within the storage medium of the presently available electronic devices.

Consequently, there is a need in the art for a method and apparatus that ensures the ability to index multimedia content for storage and retrieval.

### SUMMARY OF THE INVENTION

It is an object of the present invention to meet the above-described needs and others. Specifically, it is an overall object of the present invention to provide a method and apparatus that provides an indexing capability for the management of multimedia content. Additional objects, advantages and novel features of the invention will be set forth in the description which follows or may be learned by those skilled in the art through reading these materials or practicing the invention. The objects and advantages of the invention may be achieved through the means recited in the attached claims.

To achieve these stated and other objects, the present invention may be embodied and described as a gateway system and method having database indexing. The present invention includes a gateway, a content storage medium, and a database. The gateway receives multimedia content from a content provider or from at least one media device. The media device may be co-located with the gateway or remotely-located from the gateway. The gateway annotates the received multimedia content, using alphanumeric annotation or voice annotation, to create metadata. This metadata are information that describes the received multimedia content. The content storage medium stores the annotated multimedia content, and the database stores the metadata. The gateway is linked through a wired network or a wireless network to the media device, a television, the content storage medium, and/or the multimedia content provider.

The gateway of the present invention may also use alphanumeric annotation or voice annotation to re-create the metadata. The re-created metadata is then stored within the database and the multimedia content stored within the content storage medium is associated with the re-created metadata.

These and other features are explained below.

### BRIEF DESCRIPTION OF THE DRAWINGS

The accompanying functional drawings illustrate the present invention and are a part of the specification. Together with the following description, the drawings demonstrate and explain the principles of the present invention.

FIG. 1 is a block diagram of a personal versatile recorder according to the present invention.

FIG. 2 is a block diagram of a gateway system.

### DETAILED DESCRIPTION OF THE PREFERRED EMBODIMENTS

Using the drawings, the preferred embodiments of the present invention will now be explained. These functional embodiments are illustrative and chosen for exposition of the principles of the present invention. The invention is not, however, limited to the following embodiments, as will be appreciated by those skilled in the art.

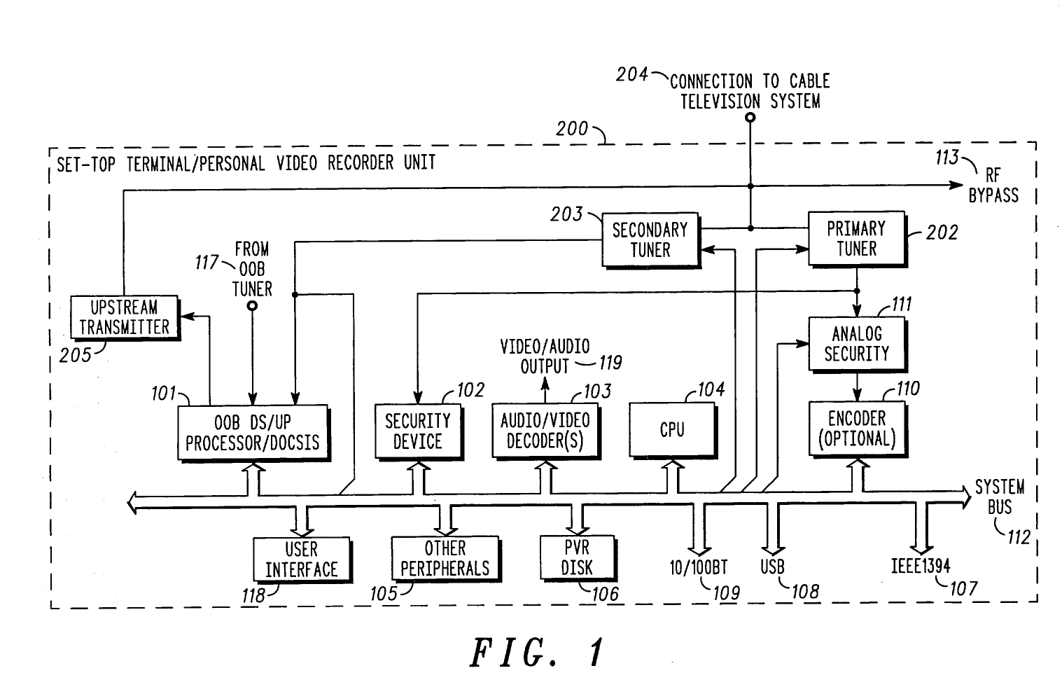

Depicted within FIG. 1 is the set-top terminal/personal versatile recorder unit (200) of the present invention. The set-top terminal/personal versatile recorder unit (200) of the present invention is a digital compression device that functions as a caching and distribution gateway for the transfer of multimedia content from the system operator and affiliated content providers. The personal versatile recorder is connected between or as part of a user's television set and cable box, satellite receiver or antenna and controls the channel tuned on the television. Incorporating a personal versatile recording device (PVR) integrated along with a set-top terminal, the set-top terminal/personal versatile recorder unit (200) performs all functions of a traditional set-top terminal while performing additional features that include, but are not limited to content management, such as recording, buffering, and retrieving multimedia content. This device provides the integrated capacity to store, replay, retrieve, and distribute content.

The set-top terminal/personal versatile recorder unit (200) also permits access to the Internet, provides electronic mail (email), video-on-demand, and impulse pay-per-view, and also performs as a personal versatile recorder to record and playback any multimedia content. Any streamed or non-streamed content can be received by the set-top terminal/personal versatile recorder unit (200) either as an analog signal or as a digital data stream, Internet Protocol, and the like. This content includes a wide variety of data or multimedia data files and formats, such as compressed audiovisual files, video files, picture and graphics files, HyperText Markup Language (HTML) files, Extended Markup Language (XML) files, text files, application software files, Internet Protocol, electronic mail (e-mail), universal resource locator (URL) links, or any combination of the above. The multimedia content also includes audio recordings in the form of multiple user-selectable audio streams and audiovisual programming in the form of digital data. Audiovisual programming such as a television broadcast in the form of compressed or pre-compressed data or in the form of an analog signal, or webcast streaming media are all sources of multimedia content.

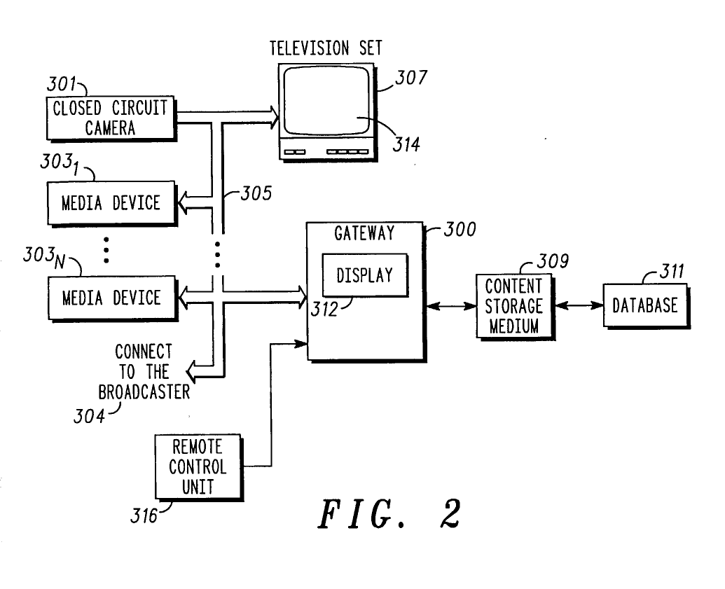

A user interface (118) is incorporated within the set-top terminal/personal versatile recorder unit (200). The user interface (118) permits the user to control and interact with the set-top terminal/personal versatile recorder unit (200). The user interface (118) comprises any control devices with which the user inputs commands to the set-top terminal/personal versatile recorder unit (200) such as a keypad, a keyboard, a microphone, a trackball, a joystick, knobs, dials, switches, and the like. The user interface (118) inputs commands to application software executed by the central processing unit (104). This software provides display menus that are navigated using a remote control unit (316) as shown in FIG. 2. This remote control unit (316), which is an integral part of the user interface (118), wirelessly transmits commands to the set-top terminal/personal versatile recorder unit (200). The user interface (118) also permits the entry of commands to the corresponding applications that are executing on the central processing unit (104) to perform the features that include, but are not limited to, the recording of multimedia content, the selection of content to be downloaded from the Internet, and the selection of other operations or setting other parameters associated with an agent application.

When a microphone is connected to or built into the recorder of the present invention, it could also be utilized to facilitate voice-recognition based navigation and menu or function selection instead of relying strictly on utilizing a remote control unit of the user interface (118). For example, the central processing unit (104) may execute a voice recognition program, or a voice recognition circuit may be included in the user interface (118) to which the output of a microphone (connected or built-in) is supplied. Consequently, spoken commands may be translated into digital commands for input parameters or instructions to the recorder.

The set-top terminal/personal versatile recorder unit (200) includes the personal versatile recorder disc (106) as a hard disc drive. Having the hard disc drive internal to the recorder, the set-top terminal/personal versatile recorder unit (200) supplants the video cassette as a content recording medium. The personal versatile recorder disc (106), connected to the system bus (112), provides a mass data storage medium on which the central processing unit (104) caches or records any type of multimedia content. The personal versatile recorder disc (106) includes a hard drive, magnetic disc, optical disc, magneto-optical disc or the like. If the audiovisual data is streamed, e.g. webcast, data could be written onto the personal versatile recorder disc (106) for caching purposes (subsequent use by the application software on a dynamic basis) or could be permanently stored.

The set-top terminal/personal versatile recorder unit (200) of the present invention is also used to perform a caching function that decreases the bandwidth demands placed on the connected network and enhances data retrieval rates. For example, some web sites, content, and the like, could include audiovisual elements that are always constant. Therefore, rather than downloading these elements each time that web site or the content is accessed, those constant elements are recorded, or cached on the personal versatile recorder disc (106) of the recorder and retrieved from there. This decreases the bandwidth demand on the network and decreases the time required to provide the display desired by the user.

Multimedia content that is transmitted as digital data from the broadcaster to the set-top terminal/personal versatile recorder unit (200) is transmitted using Quadrature Amplitude Modulation (QAM). Using QAM, digital data bit streams are modulated onto a radio frequency (RF) carrier signal in mode such that the value of each data bit is ascertained based on the phase and amplitude of the RF carrier signal. The QAM RF carrier signal is then demodulated to recover the transmitted data using the primary tuner (202) or the secondary tuner (203), which are both in-band tuners, or the OOB data tuner (117), which is an out of band tuner.

Digital data, multimedia files and application software, are also transmitted to the set-top terminal/personal versatile recorder unit (200) over the cable television system on an out-of-band (OOB) control channel to the OOB data tuner (117). Although for bandwidth capacity considerations, the in-band (primary tuner) or the secondary in-band tuner is more suitable. An OOB data channel is utilized primarily to facilitate conditional access functions for traditional and emerging services offered by the system operator as described in the prior art.

As shown in FIG. 1, the set-top terminal/personal versatile recorder (200) of the present invention also includes a primary tuner (202). The primary tuner (202) is preferably a broadband tuner that is used to tune a particular program offered over one of the hundreds of channels available from the cable system. The multimedia content received through the primary tuner (202) is buffered and selectively recorded on the personal versatile recorder disc (106) under the control of the central processing unit (104). Additionally, other data may be embedded within the television signal received through the primary tuner (202).

The secondary tuner (203) is used mainly to tune to the data transport stream within the signal from the television system (204) to free the primary tuner (202) for more conventional tuning of a television channel that the user desires to receive. This secondary tuner (203) may operate in accordance with any multiple access modems that facilitate bi-directional communication between the set-top terminal/personal versatile recorder unit (200) and the headend (not shown). The Data Over Cable Service Interface Specification (DOCSIS) standard is used to facilitate Internet access in cable systems. The data transport stream from the DOCSIS tuner (203) is provided to a DOCSIS modem (101). The connection to the DOCSIS tuner (203) allows the central processing unit (104) to control which data stream is provided to the DOCSIS modem (101) in cases where there are multiple data transport streams comprised within the signal from the broadcaster.

The DOCSIS modem (101) communicates with the central processing unit (104) over the system bus (112), and incorporates an upstream processor that drives the transmitter (205) to facilitate upstream DOCSIS transmission as well as to support existing report-back protocols (101) used to manage the cable television system. Additionally, for bi-directional communication, an upstream transmitter (205) is provided in connection with the DOCSIS modem (101). The DOCSIS modem (101) thus provides bi-directional communication for Internet access, user requests of web pages, files, session requests, purchase requests, and the like.

A purpose of the secondary tuner (203) is to allow for the respective recording and viewing of separate audiovisual programming offered at two distinct frequencies, i.e., on different channels, or from different sources such as streamed audiovisual content from the Internet and broadcast television programming. The viewer can control the channel tuned on the television to browse a succession of channels, also known as channel-surfing. The secondary tuner (203) is used in conjunction with the primary tuner (202) to simultaneously view two different television channels or audiovisual data streams, to view a second channel or audiovisual data stream, or to “channel-surf” while concurrently recording content on an original channel selected by the primary tuner (202).

Control lines to the primary tuner (202) and the secondary DOCSIS tuner (203) are provided from the system bus (112). This allows the user to input tuning commands to the system using the user interface (118) so as to control the channel tuned by the primary tuner (202). Consequently, the two-tuner configuration allows for, inter alia, the following operating modes of interest:

a) watching an analog channel, recording a digital program (encrypted or in the clear);

b) watching a clear digital program and recording a digital program (encrypted or in the clear);

c) watching an encrypted program and recording an analog channel or a second digital program in the clear; and

d) watching picture-in-picture, where the first signal is received from the primary tuner while the second is played back or retrieved from the personal versatile recorder disc (106).

For cases a through d, as set forth hereinabove, involving an encrypted (enciphered) MPEG-2 stream, the stream goes through the security device (102) for decryption (deciphering). Such decryption is achieved within the set-top terminal/personal versatile recorder unit (200) using a data encryption standard such as the Data Encryption Standard (DES) algorithm. DES is Federal Information Processing Standard (FIPS) cryptographic algorithm that includes a bit key having a length of, for example, 56-bits. Using this algorithm, encrypted data passing through the security device (102) are decrypted to be converted into its unencrypted form. When the decrypted signal is to be watched (instead of being recorded), it is processed by the decoder (103). As shown in FIG. 1, the decoder (103) comprises a single decoder or a series of decoders.

When the television signal for that channel is an analog signal, it is then transmitted to the system bus (112) through an analog security circuit (111) for descrambling the signal when the signal is scrambled, and through an optional encoder (110) for hardware assisted compression. If the set-top terminal/personal versatile recorder unit (200) is intended to process and record only digital programming, as analog transmission is phased out, the analog security (111) and the encoder (110) as illustrated are no longer necessary. Nevertheless, the encoder (110) may be retained for encoding other analog signals from alternate analog input sources for other applications.

Within the audio/video decoder (103), the content is decoded, converted to an analog signal, and then provided to the video/audio output (119). For example, when the decrypted content is to be viewed instead of being recorded, the content is processed by the audio/video decoder (103). Additionally, the audiovisual signal recorded on the personal versatile recorder disc (106) is retrieved and processed through the audio/video decoder (103) and then provided to the video/audio outputs (119) of the set-top terminal/personal versatile recorder unit (200).

To interface the set-top terminal/personal versatile recorder unit (200) of the present invention with other devices and systems, a number of additional interfaces are provided. For example, to interface a digital camera for multimedia mail applications, an IEEE1394 digital bus (107) or a Universal Serial Bus (USB) (108) are utilized. To transfer the files to a personal computer, or 10/100BT BaseT ethernet data interface (109), can be used. Also shown are connections to other peripheral devices (105). Through the connections (105), the IEEE1394 digital bus (107), the Universal Serial Bus (USB) (108), or the 10/100BT interface (109), the set-top terminal/personal versatile recorder unit (200) may record from another peripheral device.

FIG. 2 depicts a gateway system. This gateway system manages and references the multimedia content that has been recorded on a content storage medium. The system of FIG. 2 includes a gateway (300), a closed circuit camera (301), at least one media device (303), a television set (307), a content storage medium (309), and a database (311). The gateway (300) is linked through the network (305) to one or all of at least one media device (303), the television set (307), the content storage medium (309), and the signal from the broadcaster through connection (304). The broadcaster distributes multimedia content over a telecommunication network that includes, but is not limited to the Internet, radio or a multiple-channel programming network. A multiple-channel programming network, such as high bandwidth cable, multi-channel broadcast television, direct broadcast satellite, multi-channel multi-point distribution service, or satellite master antenna television, is within the scope of the invention.

Although FIG. 2 depicts the connection (304) to receive the multimedia content from the broadcaster, the connection (304) is an optional component of the gateway system (300). The network (305) being either a wired network, a wireless network, or a combination of a wired network and a wireless network is within the scope of the invention. Network (305) being either an analog network, a digital network, or a combination of an analog network and a digital network is also within the scope of the invention.

Although FIG. 2 depicts the television set (307), the television set (307) is an optional component of the gateway system. Using network (305), the television set (307) is linked to one or all of the closed circuit camera (301), at least one media device (303), and the gateway (300).

Additionally, the gateway (300) of the present invention may be the set-top terminal/personal versatile recorder unit (200) as described herein. When the set-top terminal/personal versatile recorder unit (200) is used as the gateway (300), the connection (304) shown in FIG. 2 is the television system (204) of FIG. 1, and the television set (307) shown in FIG. 2 is linked to the video/audio outputs (119) of FIG. 1. Furthermore, an RF bypass (113) of FIG. 1 permits direct signal routing to the television set (307). The television set (307) includes a display (314).

FIG. 2 depicts at least one media device (303) as the media deviceₗ (303₁) through the media device_{N} (303_{N}), “N” being the number of media devices (303) connected to the gateway (300). Although FIG. 2 depicts the media device (303), the media device (303) is an optional component of the gateway system (300). One or all media device (303) may be linked to the gateway (300) through network (305). Through the connection (304), a broadcaster may be linked to the gateway (300) through the network (305). In addition, one or all media device (303) may be linked to the broadcaster through network (305).

A media device (303), being co-located with the gateway (300) or remotely-located from the gateway (300), transfers multimedia content to the gateway (300). This multimedia content has been previously described hereinabove. The media device (303) includes, but is not limited to the set-top terminal/personal versatile recorder unit (200) as described hereinabove, a cellular phone or other personal communication device, a compact disc (CD) player, digital versatile disc (DVD) player, a hand-held computer, a modem, an optical disc player, a personal digital audio player, a personal computer (PC), a personal digital assistant (PDA), a personal video recorder, a portable computer, a portable player such as a personal digital audio player and an MPEG Layer 3 (MP3) player, a video player, a video recorder (analog or digital), a set top terminal box, or any other device capable of generating a digital bit stream or an analog signal.

The gateway (300) may receive the multimedia content from the broadcaster through the connection (304). Multimedia content is transmitted from the broadcaster as digital data, as an analog signal, or as a combination of digital data and an analog signal. The gateway (300) may also receive the multimedia content from at least one the media device (303). When received, routing of the multimedia content by the gateway (300) to the content storage medium (309) is also within the scope of the present invention. In addition, the gateway (300) may route the received multimedia content to the television set (307). Thus, the gateway (300) is a conduit for the management of the multimedia content. The gateway (300) of the present invention may be the set-top terminal/personal versatile recorder unit (200) as described hereinabove or any device that is capable of receiving and outputting information in the form of a digital or analog signal.

The multimedia content received from the gateway (300) is archived within the content storage medium (309) as a data file. The data file contains the multimedia content to be managed by the gateway system of FIG. 2. The content storage medium (309) being a single storage medium or being multiple storage media is within the scope of the present invention. The content storage medium (309) includes, but is not limited to the set-top terminal/personal versatile recorder unit (200) as described hereinabove, a compact disc (CD), a digital versatile disc (DVD), a floppy disc, a hand-held computer, a magnetic disc, an optical disc, a personal computer (PC), a personal digital assistant (PDA) with storage capability, a portable computer, an MP3 player, a video recorder (analog or digital), a set top terminal box with storage capability, a stationary device capable of storing content, a mobile or portable device capable of storing content, a removable storage medium, a portable storage medium, or any other device capable of storing a digital bit stream, either as a stand-alone unit or as part of another stationary or portable device.

Present invention permits the creation metadata. This metadata are information that describes the multimedia content. This information may include, but is not limited to, the file size of the stored multimedia content, the type of content to be stored within the content storage medium (309) as the multimedia content, the origin of the multimedia content, size, the formatting of the multimedia content or of the content storage medium (309). Once created, the metadata is uniquely associated with its multimedia content.

The remote control unit (316) permits the annotation of any recorded content to allow the access to and manipulation of the recorded content. Though the remote control unit (316), the multimedia content received by the gateway (300) is annotated with index information to provide cataloging capability and to aid navigation. Either alphanumeric annotation or voice annotation is within the scope of the present invention. This annotation permits the gateway (300) to catalog, search, find, replace, sort, and list the multimedia content that is recorded on the content storage medium (309) to allow the access to and manipulation of the recorded multimedia content. To annotate the multimedia content, the index information is entered into the remote control unit (316) as a string of characters. The entered characters string is displayed on the display (312) of the gateway (300) or on the display (314) of the television set (307), or both. Using a microphone or other audio input device, voice annotation of the multimedia content through the remote control unit (316) to create the index information is also within the scope of the present invention. The gateway (300) uses the indexed information to create metadata for the multimedia content. This metadata associates the multimedia content stored within the content storage medium (309) with the index information stored within the database (311).

When the gateway (300) transfers the multimedia content onto the content storage medium (309), the metadata that corresponds to the multimedia content is transferred to the database (311). This metadata is transferred to the database (311) as a descriptor file. The descriptor file contains a descriptor or a plurality of descriptors, a descriptor being the index information. The descriptor file is stored within the database (311).

Once the metadata have been created and stored within the database (311), further customization of the annotation by editing the metadata is also within the scope of the present invention. Specifically, the updated index information is re-entered into the remote control unit (316) as a string of characters. The re-entered characters string is displayed on the display (312) of the gateway (300) or on the display (314) of the television set (307), or both. Using a microphone or other audio input device, voice annotation of the multimedia content through the remote control unit (316) to create the re-entered index information is also within the scope of the present invention. The gateway (300) uses the re-entered indexed information to re-create metadata for the multimedia content. This re-created metadata associates the previously associated multimedia content stored within the content storage medium (309) with the re-entered index information stored within the database (311).

Whereas the content storage medium (309) stores multimedia content, the descriptor file received from the gateway (300) is stored within the database (311). The file or storage location of the content storage medium (309) that is used for the storage of the multimedia content is separate and distinct from the file or storage location of the database (311) that is used for the storage of the descriptor file.

The database (311) includes, but is not limited to the set-top terminal/personal versatile recorder unit (200) as described hereinabove, a compact disc (CD), a digital versatile disc (DVD), a floppy disc, a hand-held computer, a magnetic disc, an optical disc, a personal computer (PC), a personal digital assistant (PDA) with storage capability, a portable computer, an MP3 player, a video recorder (analog or digital), a set top terminal box with storage capability, a stationary device capable of storing content, a mobile or portable device capable of storing content, a removable storage medium, a portable storage medium, or any other device capable of storing a digital bit stream, either as a stand-alone unit or as part of another stationary or portable device.

The gateway (300) may access the database (311) to process the metadata stored thereon. By processing the metadata, the gateway (300) incorporates capabilities to manage the multimedia content stored on the content storage medium (309). Using the indexed information stored on the database (311), the gateway (300) may manage the multimedia content by cataloging, searching, finding, replacing, sorting, retrieving and/or listing the multimedia content stored on the content storage medium (309).

The gateway system of FIG. 2 may catalog the multimedia content stored on the content storage medium (309). Particularly, the metadata stored within the database (311) may include information relating to the multimedia content stored within the content storage medium (309). As a feature of the present invention, the gateway (300) may generate a listing of multimedia content stored on the content storage medium (309). For example, the gateway (300) may find and retrieve the metadata for selected multimedia content stored on the content storage medium (309), or may retrieve the metadata for all multimedia content stored on the content storage medium (309). Once the metadata has been retrieved, the gateway (300) can associate the metadata stored within the database (311) with the multimedia content stored within the content storage medium (309), and generate a list of the associated multimedia content. The gateway (300) may provide the generated listing to the television set (307) as an “on-screen listing” of the multimedia content. This listing may include the above-described information that relates to the multimedia content stored within the content storage medium (309). As noted above, that information may include, but is not limited to, the file size of the stored multimedia content or the type of information that has been stored within the content storage medium (309) as the multimedia content.

The gateway system of FIG. 2 may also initiate a search of the content storage medium (309) to identify the location where the multimedia content stored on the content storage medium (309) may be found. In particular, the metadata stored within the database (311) is used by the gateway (300) to identify the content storage medium file of the content storage medium (309) that contains the associated the multimedia content. Once the content storage medium file for the associated the multimedia content has been found, the gateway system of FIG. 2 may initiate the retrieval or the replacement of the associated content storage medium file.

Retrieval of the multimedia content recorded within the content storage medium (309) is based on the metadata. Specifically, once the location where the multimedia content stored on the content storage medium (309) may be found, the gateway (300) retrieves the associated multimedia content by commanding the content storage medium (309) to output the associated multimedia content to the gateway (300). The multimedia content stored in the content storage medium (309) is then retrieved and transported to the gateway (300). Once retrieved, the gateway (300) may distribute the retrieved multimedia content to a media device (303) or to the television set (307).

Replacement of the multimedia content recorded within the content storage medium (309) is based on the associated metadata contained within the descriptor file. In particular, once the location where the multimedia content stored on the content storage medium (309) is identified, the gateway (300) stores other information on the content storage medium (309) at the location of the associated multimedia content. Storage of this other information replaces the existing associated multimedia content with the other information by over-writing the associated multimedia content.

The database (311) located within the gateway (300) or located external to the gateway (300) is also within the scope of the present invention. The content storage medium (309) being located within the gateway (300) or being external to the gateway (300) is also within the scope of the present invention.

The preceding description has been presented only to illustrate and describe the invention. It is not intended to be exhaustive or to limit the invention to any precise form disclosed. Many modifications and variations are possible in light of the above teaching. The preceding description is intended to enable others skilled in the art to best utilize the invention in various embodiments and with various modifications as is suited to the particular use contemplated. It is intended that the scope of the invention be defined by the following claims.

What is claimed is:

1. A gateway system comprising:
a gateway, a content storage medium, and a database,
said gateway receiving multimedia content, said gateway annotating said received multimedia content to create metadata, said metadata being information that describes said received multimedia content,
said content storage medium storing said annotated multimedia content, and
said database storing said metadata.

2. The system of claim 1 further comprising:
at least one media device, said at least one media device transferring multimedia content to said gateway, each said at least one media device being a device capable of generating a digital bit stream or an analog signal.

3. The system of claim 2 wherein said at least one media device is co-located with said gateway.

4. The system of claim 2 wherein said at least one media device is remotely-located from said gateway.

5. The system of claim 1 wherein said gateway is linked through a network, said network comprising a wired network or a wireless network to one of at least one media device, a television, said content storage medium, and a multimedia content provider.

6. The system of claim 1 wherein said annotated multimedia content is annotated using alphanumeric annotation or voice annotation.

7. The system of claim 1 wherein said gateway re-creates said metadata, said re-created metadata being stored within said database, said associated multimedia content stored within said content storage medium being associated with said re-created metadata.

8. The system of claim 1 wherein said gateway transfers said annotated multimedia content onto said content storage medium and transfers said metadata onto said database.

9. The system of claim 1 wherein said gateway receives multimedia content from a content provider.

10. The system of claim 1 wherein said gateway receives multimedia content from at least one the media device.

11. The system of claim 1 wherein said gateway accesses said database to process said stored metadata.

12. The system of claim 11 wherein said gateway retrieves said stored multimedia content stored on said content storage medium.

13. The system of claim 11 wherein said gateway replaces said stored multimedia content stored on said content storage medium.

14. A gateway method comprising:
receiving multimedia content, a gateway receiving said multimedia content,
annotating said received multimedia content to create metadata, said gateway annotating said received multimedia content, said metadata being information that describes said received multimedia content,
storing said annotated multimedia content, said content storage medium storing said annotated multimedia content, and
storing said metadata, said database storing said metadata.

15. The method of claim 14 further comprising:
transferring multimedia content to said gateway, at least one media device transferring multimedia content to said gateway, each said at least one media device being a device capable of generating a digital bit stream or an analog signal.

16. The method of claim 15 wherein said at least one media device is co-located with said gateway.

17. The method of claim 15 wherein said at least one media device is remotely-located from said gateway.

18. The method of claim 14 further comprising:
linking said gateway through a network, said network comprising a wired network or a wireless network to one of at least one media device, a television, said content storage medium, and a multimedia content provider.

19. The method of claim 14 wherein said annotated multimedia content is annotated using alphanumeric annotation or voice annotation.

20. The method of claim 14 further comprising:
re-creating said metadata, said gateway performing said step of re-creating said metadata,
storing said re-created metadata stored within said database, and
associating said associated multimedia content stored within said content storage medium with said re-created metadata.

21. The method of claim 14 wherein said gateway transfers said annotated multimedia content onto said content storage medium and transfers said metadata onto said database.

22. The method of claim 14 wherein said gateway receives multimedia content from a content provider.

23. The method of claim 14 wherein said gateway receives multimedia content from at least one the media device.

24. The method of claim 14 wherein said gateway accesses said database to process said stored metadata.

25. The method of claim 11 wherein said gateway retrieves said stored multimedia content stored on said content storage medium.

26. The method of claim 11 wherein said gateway replaces said stored multimedia content stored on said content storage medium.
